(19) United States
(12) Patent Application Publication
(10) Pub. No.: US 2009/0220056 A1
(43) Pub. Date: Sep. 3, 2009

(54) Interactive Natural Language Calling System

(76) Inventors: Daniel John Simpson, Queensland (AU); Kathleen Joan Simpson, Queensland (AU); Kerri-Ann Simpson, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/086,151

(22) PCT Filed: Dec. 6, 2005
(86) PCT No.: PCT/AU2005/001844

§ 371 Date: Apr. 3, 2009

(51) Int. Cl. H04M 1/64

(52) U.S. Cl. 379/88.03; 379/88.01

(57) ABSTRACT

An interactive voice response calling system (1) for automatically dialling a plurality of telephone numbers includes database (10) containing records of dialling information for a dialling campaign. A dialler (20) translates the records i the database into dialling instructions. A calling unit (40) initiates a plurality of calls based on the dialling instruction An interactive voice response unit (30) is operably connected to the calling unit (40) upon verification by the calling unit (40) that the connected call is answered by a person. The interactive voice response unit (30) includes a natural language recognition engine that automatically determines the language of a person and responds in the determined language and storage for temporarily storing answers to the dialling campaign. The system further includes a voice print secure identification unit for verifying a voice of a subscriber, and a switch allowing the interactive voice response unit (30) to send information relating to a call to the dialler (20) for updating the dialling instructions.

### FIELD OF THE INVENTION

The present invention relates to a method and apparatus for providing an interactive calling system. In particular, although not exclusively, the invention relates to calling system incorporating interactive voice response capabilities which is designed to provide automated responses to a subscribers voice input in the subscribers natural language.

### DISCUSSION OF PRIOR ART

The provision of interactive call services to date typically has involved the need for a subscriber to enter information or respond to menu prompts via the telephone keypad.

Recent advances in technology have introduced various interactive response systems, some using voice recognition techniques, that enable a user to enter responses to menu prompts simply by speaking. A technology of a similar nature has been employed in the computer industry, where various software products are available that allow for the direct dictation of content into a type written format which is then displayed to a user by a computer.

One such example of an interactive voice recognition system in a telephony environment is that currently employed by Telstra™ Australia, whereby the subscriber carries on a conversation of sorts with the system. The user can simply select the desired menu option by simply speaking clearly and concisely into the handset. The system then identifies the subscriber's choice and selects the appropriate response, whether it be connecting the subscriber to a human operator or presenting a submenu for the selected option. This system typically tends to be an inbound calling system with the subscriber initiating the call. Furthermore these systems generally are only capable of handling one particular language for the given application (such as English) and does not provide multilingual capabilities. Telstra's system does not have the ability to recognise continuous speech, requiring the subscriber to speak in a disjointed format and not in natural sentences as with normal conversation.

Most outbound automated messaging or calling systems typically focus on automatically dialling a subscriber so that a message may be played, or delivered by an operator, or these systems employ conventional techniques such as DTMF tones for gathering subscriber responses and particulars in response to a message for later presentation to an operator.

U.S. Pat. No. 6,169,798 entitled ‘System and method for automatic call’, for example, discloses a system for automatically calling a subscriber including a storage device, a private branch exchange, originating equipment, and a plurality of operator apparatuses. The private branch exchange originates a call in response to instructions from the originating equipment and provides call information relating to the originating equipment and the destination operator apparatus. The originating equipment then stores the call information such as customer telephone number etc in a storage device linked with the call information. When a response from a called subscriber is transferred to the operator apparatus, the destination operator apparatus retrieves the called subscriber ID information from the storage device by using the call information as a key and obtains the individual information of the called subscriber, which is then displayed to the operator. Generally, this type of system uses conventional means for obtaining subscriber responses such as DTMF tones entered via a keypad, and does not typically provide interactive voice response capabilities for obtaining subscriber responses.

Another such example of an automated calling system is that of U.S. Pat. No. 6,463,426 entitled ‘Automated system and method for delivery of messages and processing of message responses’, which discloses a system for sending messages to multiple recipients, and for processing of responses to the messages. The system includes a message client, message server, and system database. The message is created using a universal message format. The message content can then be translated into multiple formats and sent to one or more different recipients using one or more different types of messaging devices, including pagers, telephones, fax machines, and e-mail readers. A recipient profile manager allows each recipient to select the messaging devices to be used for message delivery as well as preferred messaging schedules, priorities, and message security. Receipt of the messages by the recipients is verified, response requirements collected and consolidated from multiple sources and presented to the message originator in a structured format. Such a system typically requires a subscriber to respond via conventional means such as keypads or keyboards and does not typically provide multilingual interactive voice capabilities for obtaining subscriber responses.

None of the prior art systems described above provide a calling system, which is capable of handling either inbound or outbound calls, and which is responsive to the natural language of the dialled subscriber. Accordingly, there is a need for a calling system that is able to recognise whether a connected subscriber is indeed a person, if so identify the language in which the connected person communicates, and then provide the desired information to the connected person in their language of choice.

Furthermore, the above described systems do not provide capable of continuous speech recognition and sentence structure analysis. Accordingly, there is a need for a calling system that is capable of natural language and continuous speech recognition.

In our earlier Australian innovation patent no 2004100016, filed 15 Jan. 2004, I describe an interactive voice response calling system and an interactive voice response debt collection system. The entire contents of my earlier Australian innovation patent are herein incorporated by cross reference.

### SUMMARY OF THE INVENTION

The present invention provides an interactive voice response calling system for automatically dialling a plurality of telephone numbers, said system including:

a database containing a plurality of records, said records relating to dialling information for a dialling campaign;

a dialler operably connected to the database, said dialler receiving and translating the records relating to the dialling campaign from said database into dialling instructions;

a calling unit connected to the dialler and a plurality of communication lines, said calling unit receiving from the dialler the dialling instructions, and then initiating a plurality of calls based on said dialling instructions;

an interactive voice response unit being operablely connected to the calling unit upon verification by the calling unit that the connected call is answered by a person, said interactive voice response unit including:
a natural language recognition engine, said engine responsive to voice input from the person wherein the natural language engine automatically determines the language of the person and responds in the determined language; and
storage for temporarily storing answers to the dialling campaign;
a voice print secure identification unit coupled to the interactive voice response unit for verifying a voice of a subscriber; and

a switch coupled to the interactive voice response unit and the dialler, said switch allowing the interactive voice response unit to send information relating to a call to the dialler, said dialler then updating the dialling instructions.

In another form of the present invention there is provided an interactive voice response debt collection system for automatically dialling a plurality of telephone subscribers, said system including:

a database containing a plurality of records, said records relating to dialling information for a dialling campaign;

a dialler operably connected to the database, said dialler receiving and translating the records relating to the dialling campaign from said database into dialling instructions;

a calling unit connected to the dialler and a plurality of communication lines, said calling unit receiving from the dialler the dialling instructions, and then initiating a plurality of calls based on said dialling instructions;

an interactive voice response unit being operably connected to the calling unit upon verification by the calling unit that the connected call is answered by a person, said interactive voice response unit including:
a natural language recognition engine, said engine responsive to voice input from the person wherein the natural language engine automatically determines the language of the person and responds in the determined language;
storage for temporarily storing answers to the dialling campaign;

a voice print secure identification unit coupled to the interactive voice response unit for verifying a subscriber; and

an online payment authorisation portal coupled to the interactive voice response unit said payment portal retrieving from the interactive voice response unit storage a subscribers payment details, said payment portal then initiating a payment transaction based on the retrieved payment details and updating the subscribers records on completion of the transaction.

The interactive voice response debt collection system may further include a switch coupled to the interactive voice response unit and the dialler, said switch allowing the interactive voice response unit to send information relating to a call to the dialler, said dialler then updating the dialling instructions;

The voice print secure identification unit may operate in any suitable fashion that enables verification of a subscriber by the unit by analysing the voice of the subscriber. For example, the voice print secure identification unit may receive a sample of the subscriber's voice and store that sample for later retrieval and use to verify the subscriber's voice by comparing the retrieved sample with the subscriber's live voice sample. In one embodiment, the sample of the subscriber's voice may be analysed and one or more characteristics of the analysed sample stored in a database. When it is desired to verify the identity of a subscriber, the subscriber's live voice may be analysed to determine one or more characteristics of the live voice and the one or more characteristics of the live voice compared with the one or more characteristics of the sample voice stored in the database.

In one embodiment, the voice print secure identification unit may initially create a biometric template of the subscriber's unique voice print by asking the subscriber to state a phrase or unique identifier in the subscriber's natural language. The voice print identification unit may extract distinctive vocal characteristics, such as one or more of tone, pitch, or cadence, and/or the measurable acoustic patterns of the speech. The voice print secure identification unit may store the distinctive vocal characteristics or measurable acoustic patterns in a secure database for later retrieval from the Voice Print Database and use the retrieved distinctive vocal characteristics or measurable acoustic patterns to verify the subscriber by conducting a comparison against the subscriber's live voice sample.

Typically, the voice print secure identification unit will convert the subscriber's speech (both the sample and the live speech) from analogue into digital format.

In another form of the invention, there is provided a method of calling a plurality of subscribers, said method including:

formulating a campaign and storing said campaign on a database with a plurality of campaigns in a record format;

selecting at least on campaign from the plurality of campaigns for download to a dialler;

translating the selected campaign form the record format of the database into dialling instructions, and transmitting the dialling instructions to a calling unit;

initiating a plurality of calls from a calling unit based on the received dialling instructions;

verifying that the connected call is answered by a person, and upon verification transferring the call to an interactive voice response unit;

determining the connected persons natural language using a natural speech recognition engine, said engine responsive to voice input from the person wherein the natural language engine automatically determines the language of the person;

verifying a subscriber using a voice print secure identification procedure;

presenting the selected campaign in the determined language and temporarily storing answers to the presented campaign, and responding to said answers in the determined language; and

updating campaign information stored on the database based on the stored answers to the selected campaign.

In yet another form of the invention, there is provided a method of automated debt collection said method including:

formulating a campaign and storing said campaign on a database with a plurality of campaigns in a record format;

selecting at least on campaign from the plurality of campaigns for download to a dialler;

translating the selected campaign form the record format of the database into dialling instructions, and transmitting the dialling instructions to a calling unit;

initiating a plurality of calls from a calling unit based on the received dialling instructions;

verifying that the connected call is answered by a person, and upon verification transferring the call to an interactive voice response unit;

determining the connected persons natural language using a natural speech recognition engine, said engine responsive to voice input from the person wherein the natural language engine automatically determines the language of the person;

verifying a subscriber using a voice print secure identification procedure;

presenting the selected campaign in the determined language and temporarily storing payment details in response to the presented campaign, and responding to said answers in the determined language;

transmitting said payment details to an on line payment authorisation portal, said portal then initiating a payment transaction based on the received payment details;

updating campaign information stored on the database based on the outcome of said payment transaction.

In embodiments of the methods of the present invention, the voice print secure identification procedure may operate in any suitable fashion that enables verification of a subscriber by analysing the voice of the subscriber. For example, the voice print secure identification procedure may receive a sample of the subscriber's voice and store that sample for later retrieval and use to verify the subscriber's voice by comparing the retrieved sample with the subscriber's live voice sample. In one embodiment, the sample of the subscriber's voice may be analysed and one or more characteristics of the analysed sample stored in a database. When it is desired to verify the identity of a subscriber, the subscriber's live voice may be analysed to determine one or more characteristics of the live voice and the one or more characteristics of the live voice compared with the one or more characteristics of the sample voice stored in the database.

In one embodiment, the voice print secure identification procedure may initially create a biometric template of the subscriber's unique voice print by asking the subscriber to state a phrase or unique identifier in the subscriber's natural language. The voice print identification procedure may extract distinctive vocal characteristics, such as one or more of tone, pitch, or cadence, and/or the measurable acoustic patterns of the speech. The voice print secure identification procedure may store the distinctive vocal characteristics or measurable acoustic patterns in a secure database for later retrieval from the database and use the retrieved distinctive vocal characteristics or measurable acoustic patterns to verify the subscriber by conducting a comparison against the subscriber's live voice sample.

Typically, the voice print secure identification procedure will convert the subscriber's speech (both the sample and the live speech) from analogue into digital format.

Preferably, the dialling unit is an auto-dialler, alternately the dialler may be a computer running a dialling program or protocol.

The calling unit may be any suitable device capable of placing a plurality of calls across a given network, and is most preferably a private area branch exchange (PABX) for placing calls to the public switched telephone network (PSTN).

Preferably the switch is a local area network (LAN) switch. Alternatively, the switch may be a hub.

The online payment authorisation portal preferably conducts transactions across a secure network connection such as a secure internet connection or a dedicated private line.

### BRIEF DETAILS OF THE DRAWINGS

In order that this invention may be more readily understood and put into practical effect, reference will now be made to the accompanying drawings illustrate preferred embodiments of the invention, and wherein:

FIG. 1 is a schematic block diagram of the system of one embodiment of the present invention;

FIG. 2 (a) is a flow chart depicting the operation of the embodiment illustrated in FIG. 1;

FIG. 2 (b) is the continuation of the flow chart of FIG. 2 (a);

FIG. 3 is a schematic block diagram of a further embodiment of the present invention;

FIG. 4 (a) is a flow chart depicting the operation of the embodiment illustrated in FIG. 3;

FIG. 4 (b) is the continuation of the flow chart of FIG. 4 (a) and

FIG. 5 is a flow chart showing the inclusion of voice print verification into the flow charts shown in FIGS. 4 (a) and 4 (b).

### DESCRIPTION OF THE PREFERRED EMBODIMENTS

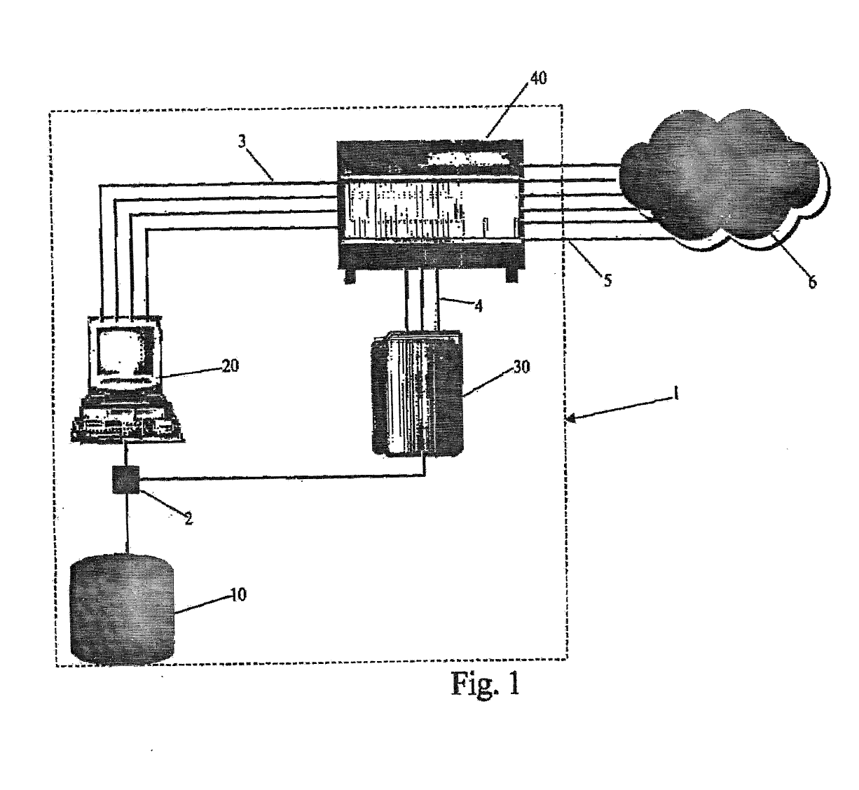

Referring to FIG. 1 there is illustrated an automated interactive natural language calling system (1) of a first embodiment of the invention. The system of the embodiment includes a database (10), a dialler (20), an interactive voice response unit (IVR) (30) and a calling unit in the form of a private area branch exchange (PABX) (40), which may switch between the dialler and the IVR as required.

The database (10) stores and maintains a plurality of records relating to the subjects of various dialling campaigns. The records may contain such information as subscriber identification number, account details, address and payment history etc.

The dialler (20) and the IVR (30) may be connected to the database via a local area network (LAN) (2) depending on the desired application. For example in a marketing or survey application, it may be advantageous to have both the dialler, the IVR and the database operably interconnected via the LAN allowing the database and the dialler records to be updated in real-time. For other application such as politic or emergency announcements (i.e. typically a one off message), may only require the IVR and the dialler to be operably connected via the LAN.

Typically the dialler (20) is connected via a plurality of communication lines (3) to the PABX (40). The PABX is further connected to the IVR (30) and a communications network (6) via communication lines (4) and (5) respectively.

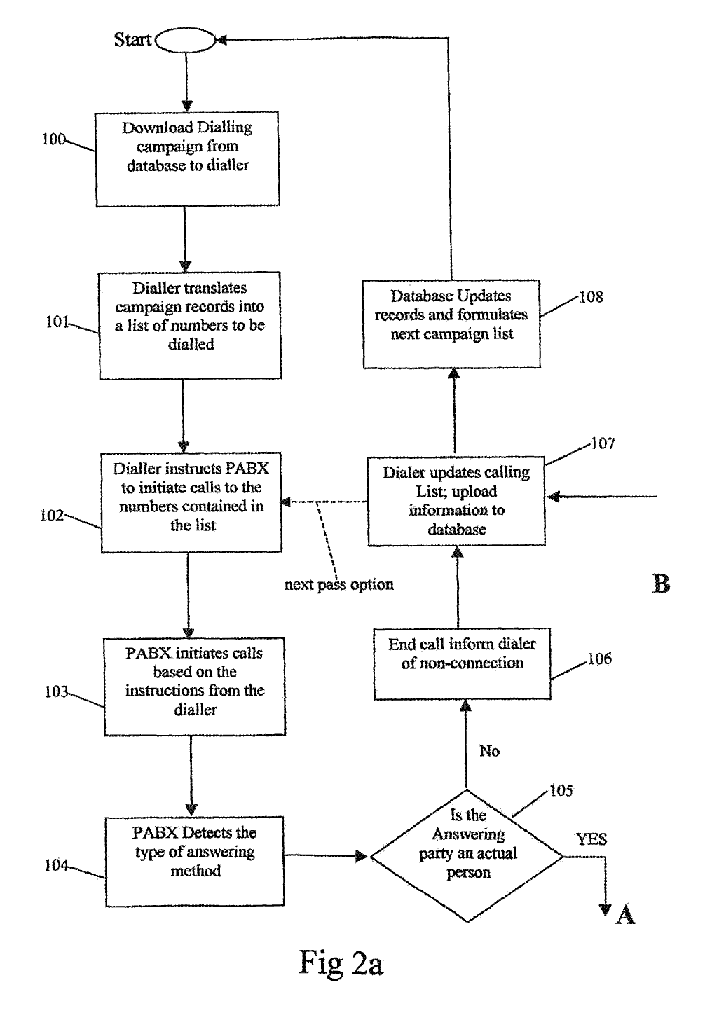

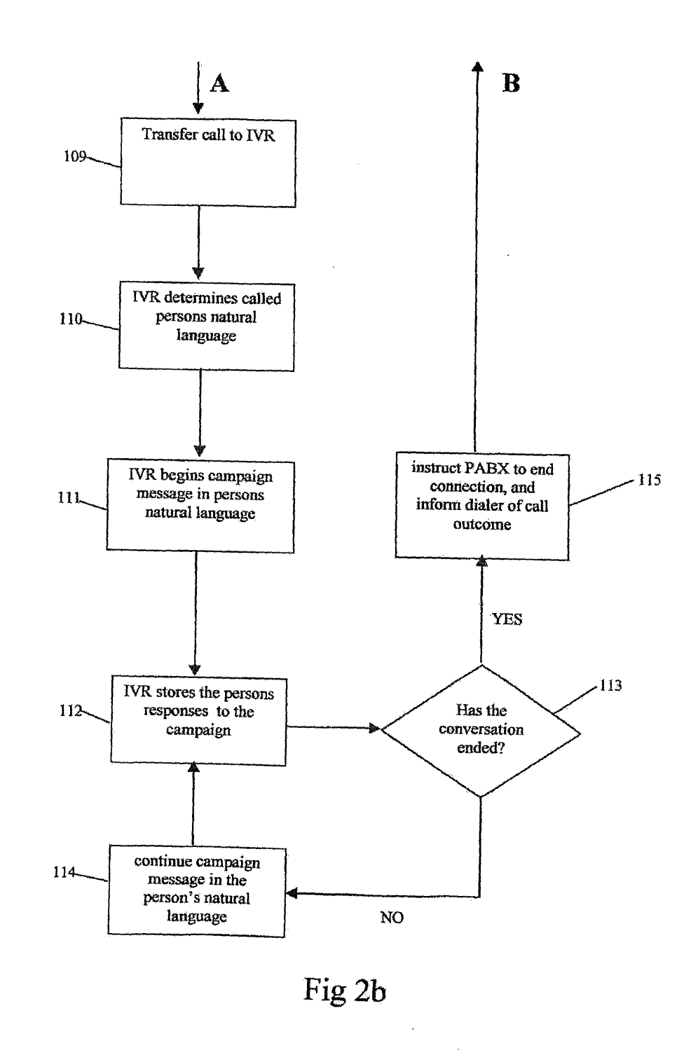

The operation of the system as illustrated in FIG. 1 will be better understood with reference to the flow charts shown in FIG. 2a and FIG. 2b. The desired dialling campaign is downloaded from the database to the dialler (100). Each dialling campaign may be specifically tailored to meet the particular requirements of the desired application.

The downloaded dialling campaign is typically in a format specified for the database, which format is not readily recognised by the PABX. Upon receiving the campaign data, the dialler must firstly translate the campaign data into a format recognisable by the PABX (101). Typically this is a list of subscriber telephone numbers, with each number directly corresponding to a record in the database. The dialler then instructs the PABX to initiate calls to the each number contained in the list (102). The PABX then begins to establish connections to each of the subscriber numbers provided by the dialler (103).

Once the PABX establishes a connection with a given subscribers number it then proceeds to detect the method of answer at the receiving end (104). The PABX attempts to determine whether the answering party is an actual person (105). If the answering party is anything other an actual person, such as a fax or answering machine, the PABX terminates the connection and informs the dialler of the call failure (106). The dialler then stores this data for later use (107). The stored data may either be uploaded the database (108), which then collates all successful and unsuccessful call connections and then updates all relevant fields relating to a subscribers records in real-time based on the call outcome. These update records can then be used as a basis for a new dialling campaign. Alternatively, the dialler may simply instruct the PABX to attempt to establish a connection to the numbers where the connection was judge to have failed after a predetermined interval (102). For example, the dialler may instruct the PABX to attempt to establish a connection on a second pass of the list to only those numbers which failed on the first pass before informing the database of a failure to connect with an actual person.

If the PABX determines that the answering party is an actual person, it then transfers the call to the IVR (109). The IVR then determines the called person's natural language (110). The language determination is performed by a natural language speech recognition (NLSR) engine housed within the IVR. Essentially the NLSR engine is software driven and is capable of not only recognising the person's natural language, but also has the ability to comprehend continuous speech and also perform sentence structure analysis. This sophisticated engine enables the subscriber to communicate with the automated system simply by speaking in an ordinary manner.

This is opposed to most current systems, which require the subscriber to communicate in a disjointed format. For example if the subscriber desired to enter the number 22 most current systems would require the subscriber to speak out each number namely “two”, “two” where as the NLSR engine allows the user simply to speak the number as they normally would namely “twenty two”. As far as the subscriber is concerned, the interaction with the automated system of the present invention is similar to that of a normal conversation, allowing subscriber to use naturally formulated sentences eliminating the disjointed format increasing the ease of use to the subscriber and improving system efficiency. One such example of a commercially available NLSR engine is that supplied by AVAYA Communication Inc, which is based on technology from Nuance and Speechworks and is currently available with the capability to handle more than 18 different spoken languages.

Once the NLSR has identified the person's natural language, the IVR then presents the relevant campaign message(s) in the identified language (111). The IVR then identifies the person's responses to the campaign prompt(s) and temporally stores these responses (112). The IVR continues to monitor the conversation to determine whether the conversation has concluded (113). If the conversation has not concluded, the IVR continues to present the campaign information in the identified language (114). Once the conversation has been determined as being completed due to either, the completion of the campaign message, the called party terminating the call or a period of inactivity on the line, the IVR then instructs the PABX to terminate the call, and informs the dialler of the outcome of the call (115). If the dialled party terminates the call prematurely or the line has been idle for a predetermined period (e.g. 1 minute) the system may then regard this as a failed connection, and as such the IVR instructs the PABX to close the connection, and then inform the dialler of the call failure. If the IVR determines that the call was successful, (i.e. complete message was relayed) it then instructs the PABX to close the connection, and informs the dialler that the subscriber has been successfully contacted.

Upon the closure of the connection the dialler becomes aware of a free ports on both the IVR and the PABX and instructs the PABX to make more calls as required to maintain the maximum number of IVR ports occupied to increase system efficiency.

Once the dialler has ascertained from the IVR whether the call was successful or unsuccessful it then proceeds to update the call list accordingly in real-time, as per step (107). The dialler then may proceed as previously discussed by either uploading this data to the database (108), or starting the calling process once again (102), depending on the systems configuration.

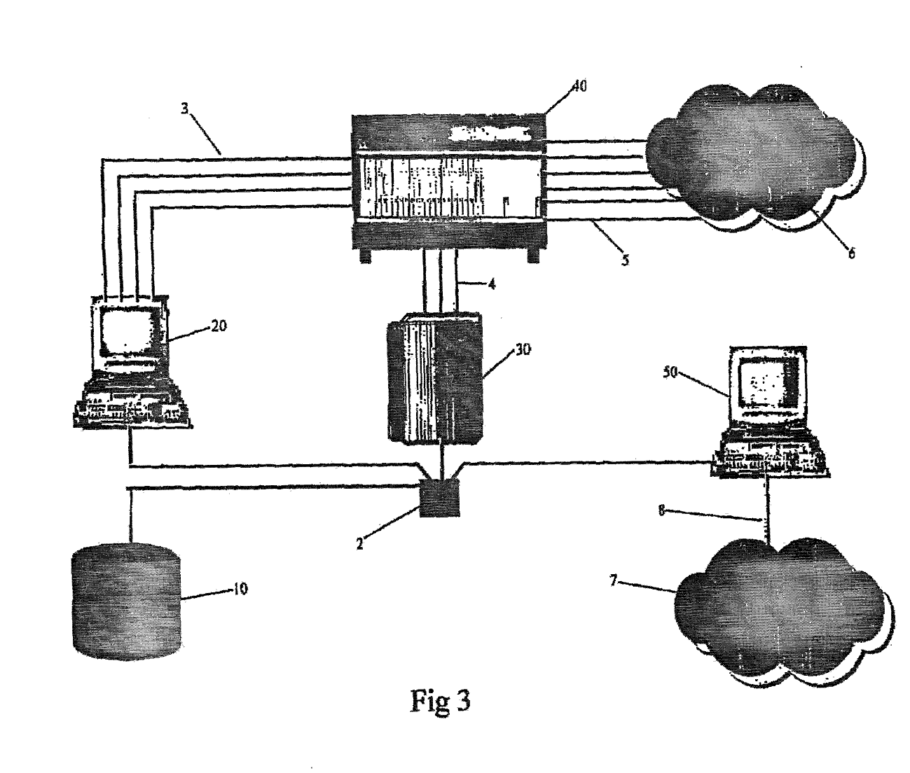

FIG. 3 illustrates a schematic block diagram of a further embodiment of the present invention suited to debt recovery. Unless otherwise indicated the same reference numerals are used to refer to the same components as in FIG. 1.

The illustrated debt recovery system of FIG. 3 consists of a database (10), a dialler (20), an interactive voice response unit (IVR) (30); a private area branch exchange (PABX) (40) and an on-line payment authorisation portal (OLPAP) (50).

The interconnection of the IVR, dialler and the PABX is similar to that previously discussed in relation to the embodiment illustrated in FIG. 1. The following description will focus mainly on the differences between this embodiment and that of FIG. 1. The major difference is the addition of the on-line payment authorisation portal (OLPAP) and its effect on the interconnection, configuration and functioning of the system.

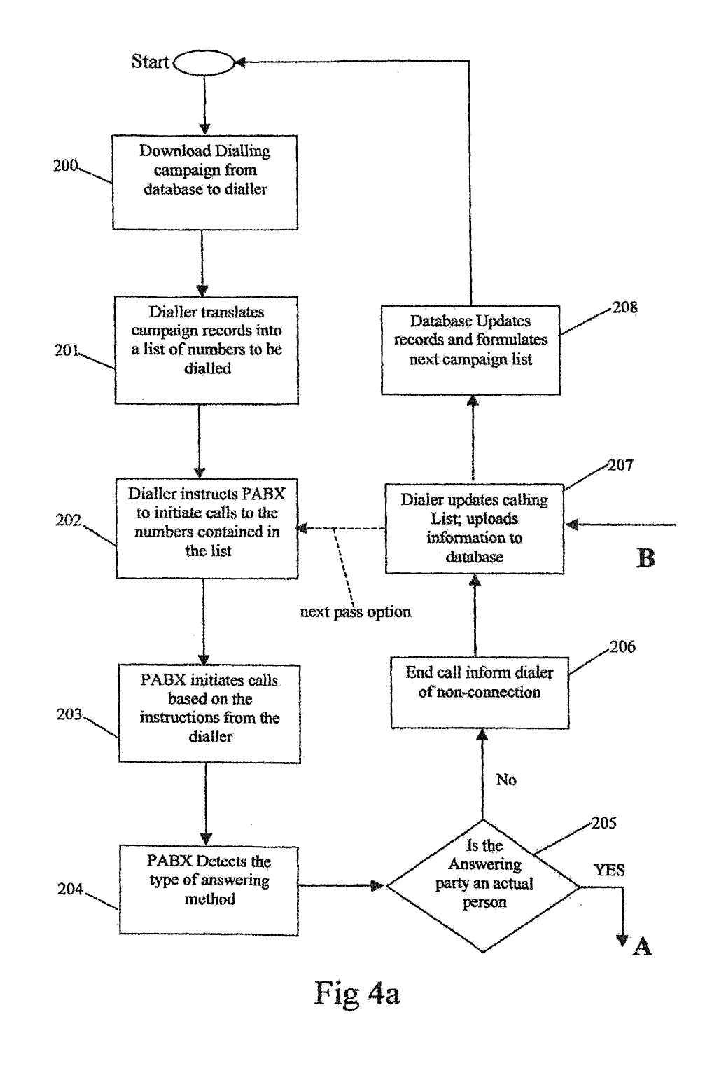

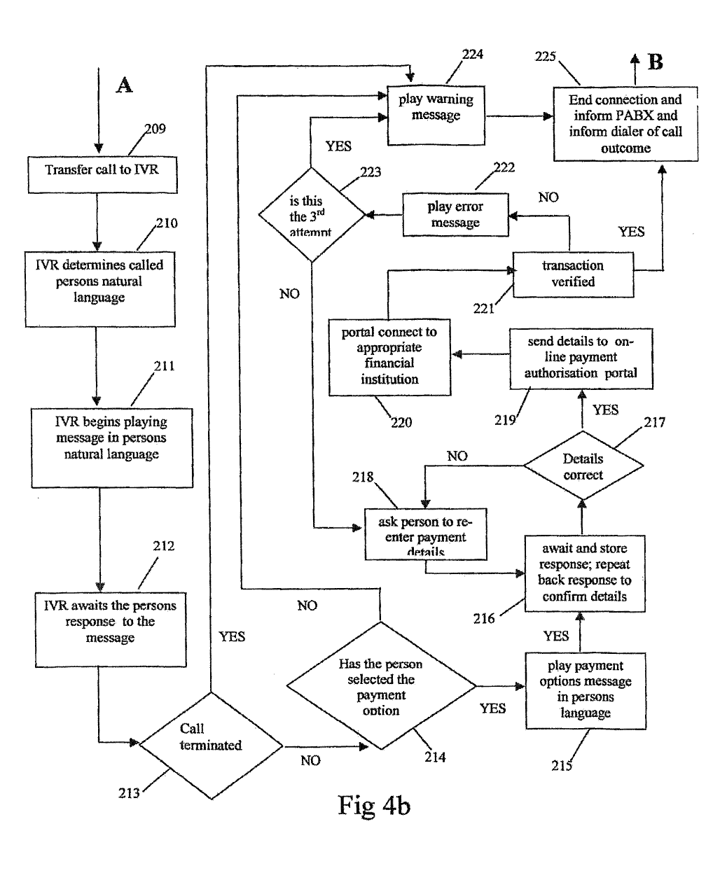

As previously discussed it advantageous to interconnect the dialler and/or the IVR via a LAN to the database, depending on the systems desired application. In the case of the debt recovery system of FIG. 4, it is necessary to connect both the dialler and the IVR to the database via a LAN, with a further LAN connection provided for the OLPAP.

The OLPAP is also connected to a communication network (7) via communication lines (8). Preferably, the communication network is a secure network with appropriate safeguards such as a secure internet connection or a dedicated private line.

The operation of the debt recovery system will be better understood with reference to FIGS. 4a and 4b.

The dialling campaign is downloaded from the database to the dialler (200), the dialler then translates the dialling campaign data into a list of contact numbers (201), and then instructs the PABX to initiate calls to each of the numbers on the list (202). The PABX then initiates calls to each of the contact numbers based on the dialler's instructions (203).

Upon call connection the PABX determines the answering method at the receiving end (204) and determines whether or not the call has been answered by an actual person or whether it has been answered by automated equipment such as an answering service or machine, fax or personal computer etc (205). If the answering party is piece of automated subscriber equipment such as the examples above, the PABX terminates the connection and informs the dialler of the failure (206). The dialler then stores this data for later use (207). The stored data may either be used as the basis of a new campaign in which case the dialler uploads the data to the database (208), which then collates all successful and unsuccessful call connections and then updates all relevant fields relating to a subscriber's records in real-time based on the call outcome.

Alternatively, the dialler may simply instruct the PABX to attempt to establish a connection to the numbers where the connection is judged to have failed after a predetermined interval. For example, the dialler may instruct the PABX to attempt to establish a connection on a second pass of the list to only those numbers, which failed on the first pass (202) before informing the database of a failure to connect with an actual person.

If the PABX determines that the answering party is an actual person, it then transfers the call to the IVR (209). The IVR then determines the called person's natural language (210). The natural language determination is performed as discussed earlier by a natural language speech recognition (NLSR) engine housed within the IVR.

Once the NLSR engine has identified the person's natural language, the IVR employing the NLSR engine begins to present the appropriate message relating to the amount of money owed by the called person, and provide prompts as to the available options in the person's natural language (211). The IVR then awaits the person's responses to the collection message (212).

From the subscriber's responses to the message, the IVR determines whether the call has been terminated (213), or whether the subscriber has elected to pursue payment of the outstanding debt (214). In the event of a negative response to pursuing payment at this time, the IVR plays an appropriate warning message (224) to the subscriber, before instructing the PABX to terminate the call and, informing the dialler of the outcome of the call (225).

In the case of premature call termination by the called person, or a period of prolonged inactivity on the line the IVR instructs the PABX to close the connection, and informs the dialler of the call failure (225). Upon the closure of the connection the dialler becomes aware of a free ports on both the IVR and the PABX and instructs the PABX to make more calls as required to maintain the maximum number of IVR ports occupied to increase system efficiency.

If the called subscriber elects to proceed with payment of the outstanding amount, the system then proceeds to present the various payment options available (215). The IVR then awaits the person's selection of a payment option and the entry of the relevant payment details (i.e. credit card number, expiry date, etc.) and temporarily stores this information for play back to the called person (216) in order to confirm the accuracy of the captured details (217). If the details are in error, the system then prompts the subscriber to repeat their payment details again (218). If the captured details are confirmed as being correct, the IVR then forwards them via the LAN to the OLPAP (219).

The OLPAP then connects to the relevant financial institution and process the transaction (220). The OLPAP then awaits verification that the transaction has been successfully processed (221). If a positive acknowledgement is received from the financial institution in respect of the transaction, the OLPAP then informs the IVR of the completion of the transaction, which inturn instructs the PABX to terminate the call, and informs the dialler of the call outcome (225).

If the transaction is denied for reasons such as a connection failure or insufficient funds available etc., the OLPAP instructs the IVR to inform the subscriber of the error in processing the transaction (222). The system then accesses the number of attempts made at processing the transaction (223). If the number of attempts is greater than a set threshold (in this case it is illustrated as 3 attempts) the IVR then proceeds to play an appropriate warning message (224), before instructing the PABX to close the call, and informing the dialler of the call outcome (225).

Once the dialler has ascertained from the IVR that the call has been successful or unsuccessful, it then updates the contact list accordingly, as per step (207). The dialler then may proceed as previously discussed by either uploading this data to the database (208), or it may start the calling process once again (202), depending on system configuration.

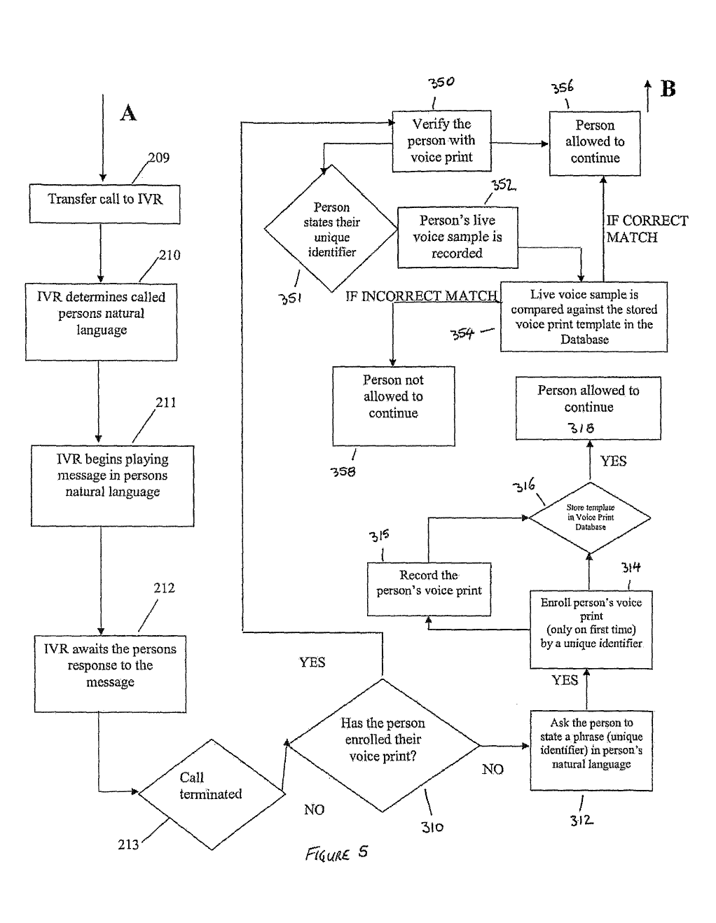

FIG. 5 shows a further embodiment of the present invention. The flow chart of FIG. 5 may be incorporated into the Flowchart shown in FIG. 4(b). The flowchart shown in FIG. 5 allows for the verification of a person, such as a subscriber, by the system. This may be useful in applications such as a variety of commerce and customer service applications. Also known as voice verification, it can be incorporated into solutions including applications for improving identification security and is a method of preventing ID fraud or theft.

In the embodiment shown in FIG. 5, after step 213 (from FIG. 4(b)), the voice verification unit checks if the person on the line has enrolled their voice print (at 310). If yes, the system and method moves to step 350, which involves verification of the person's identity.

If the person on the line has not enrolled their voice print, the person is asked to state a phrase or a unique identifier in the person's natural language (at 312). The person's voice print is enrolled at 314 by a unique identifier. The person's voice print may be recorded at 315 and the person's voice or voice characteristics are recorded in a database, referred to as a voice print database 316. The voice print database is a secure database having appropriate security protocols in operation.

The person on the line is then allowed to continue (at 318).

From step 318, the process will transfer to step 350. If the person had previously enrolled their voice print, steps 312 to 318 would be bypassed and the person moved directly to step 350 of the process. Step 350 relates to verification of the identity of the person on the line. The person is required to state their unique identifier (at 351). The person's live voice sample, obtained when the person on the line states their unique identifier, is recorded (at 352) and the live voice sample is compared (at 354) against the stored voice print template in the voice print database. If the live voice sample is determined to match the stored voice print, the person is allowed to continue (356). If the flowchart forms part of the flowchart shown in FIG. 4(b), the person then proceeds to step 214 shown in FIG. 4(b),

In the embodiment shown in FIG. 5, the system may create a biometric voice print of the caller. The biometric voice print may be, for example, a template of the person's unique voice characteristics. That template is created when the person enrolls with the system, whereby for any subsequent calls the person's live voice sample is compared against the pre-recorded sample. There are three stages to the authentication process (i) enrolment; (ii) identification; and (iii) verification. Through a one-time enrolment process where the person speaks a short phrase (for example, the person's unique identification number or telephone number) the system collects voice samples resulting in a mathematical representation of the person's voice, which defines the person's distinctive voice characteristics to discriminate between speakers. These characteristics are based on many factors, including the unique physiology of the physical structure of their vocal tract and their unique speech patterns.

A spoken phrase is then converted from analogue to digital format extracting the distinctive vocal characteristics, such as tone, pitch, cadence, and the measurable acoustic patterns on the speech.

The voice prints are stored in a secure database and are later used to verify the person, whereby the system locates the person's stored voice print from the database then completes the verification based on the person's unique speech. The verification process may involve extraction of the distinctive vocal characteristics, such as tone, pitch, cadence, and the measurable acoustic patterns on the speech, fro the live voice of the person on the line (or from the recording of the live voice of the person on the line).

The voice verification process described above may be used in the flowchart shown in FIGS. 1 and 2.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. An interactive voice response calling system for automatically dialling a plurality of telephone numbers, said system including:
a database containing a plurality of records, said records relating to dialling information for a dialling campaign;
a dialler operably connected to the database, said dialler receiving and translating the records relating to the dialling campaign from said database into dialling instructions;
a calling unit connected to the dialler and a plurality of communication lines, said calling unit receiving from the dialler the dialling instructions, and then initiating a plurality of calls based on said dialling instructions;
an interactive voice response unit being operably connected to the calling unit upon verification by the calling unit that the connected call is answered by a person, said interactive voice response unit including:
a natural language recognition engine, said engine responsive to voice input from the person wherein the natural language engine automatically determines the language of the person and responded in the determined language; and
storage for temporarily storing answers to the dialling campaign;
a voice print secure identification unit coupled to the interactive voice response unit for verifying a voice of a subscriber; and
a switch coupled to the interactive voice response unit and the dialler, said switch allowing the interactive voice response unit to send information relating to a call to the dialler, said dialler then updating the dialling instructions.

2. An interactive voice response debt collection system for automatically dialling a plurality of telephone subscribers, said system including:
a database containing a plurality of records, said records relating to dialling information for a dialling campaign;
a dialler operably connected to the database, said dialler receiving and translating the records relating to the dialling campaign from said database into dialling instructions;
a calling unit connected to the dialler and a plurality of communication lines, said calling unit receiving from the dialler the dialling instructions, and then initiating a plurality of calls based on said dialling instructions;
An interactive voice response unit being operably connected to the calling unit upon verification by the calling unit that the connected call is answered by a person, said interactive voice response unit including:
a natural language recognition engine, said engine responsive to voice input from the person wherein the natural language engine automatically determines the language of the person and responds in the determined language;
storage for temporarily storing answers to the dialling campaign;
a voice print secure identification unit coupled to the interactive voice response unit for verifying a subscriber; and
an online payment authorisation portal coupled to the interactive voice response unit said payment portal retrieving from the interactive voice response unit storage a subscribers payment details, said payment portal then initiating a payment transaction based on the retrieved payment details and updating the subscriber records on the completion of the transaction.

3. An interactive voice response debt collection system as claimed in claim 2 further including a switch coupled to the interactive voice response unit and the dialler, said switch allowing the interactive voice response unit to send information relating to a call to the dialler, said dialler then updating the dialling instructions.

4. A system as claimed in claim 1 wherein the voice print secure identification unit receives a sample of the subscriber's voice and stores that sample for later retrieval and use to verify the subscriber's voice by comparing the retrieved sample with the subscriber's live voice sample.

5. A system as claimed in claim 4 wherein the voice print secure identification unit analyses the sample of the subscriber's voice and one or more characteristics of the analysed the subscriber's live voice to determine one or more characteristics of the live voice and the one or more characteristics of the live voice are compared with the one or more characteristics of the sample voice stored in the database.

6. A system as claimed in claim 4 wherein the voice print secure identification unit creates a biometric template of a subscriber's unique voice print by asking the subscriber to state a phrase or unique identifier in the subscriber's natural language and extracts distinctive vocal characteristics and/or measurable acoustic patterns of the speech and stores the distinctive vocal characteristic or measurable acoustic patterns in a secure database for later retrieval from the secure database, and uses the retrieved distinctive vocal characteristic or measurable acoustic patterns to verify the subscriber by conducting a comparison against the subscriber's live voice sample.

7. A system as claimed in claim 4 wherein the voice print secure identification unit converts the subscriber's speech from analogue into digital format.

8. A method of calling a plurality of subscribers, said method including:
formulating a campaign and storing said campaign on a database with a plurality of campaigns in a record format;
selecting at least on campaign from the plurality of campaigns for download to a dialler;
translating the selected campaign form the record format of the database into dialing instructions to a calling unit;
initiating a plurality of calls from a calling unit based on the received dialling instructions;
verifying that the connected call is answered by a person, and upon verification transferring the call to an interactive voice response unit;
determining the connected persons natural language using a natural speech recognition engine, said engine responsive to voice input from the person wherein the natural language engine automatically determines the language of the person;
verifying a subscriber using a voice print secure identification procedure;
presenting the selected campaign in the determined language and temporarily storing answers to the presented campaign, and responding to said answers in the determined language; and
updating campaign information stored on the database based on the stored answers to the selected campaign.

9. A method of automated debt collection said method including:
formulating a campaign and storing said campaign on a database with a plurality of campaigns in a record format;
selecting at least one campaign from the plurality of campaigns for download to a dialler;
translating the selected campaign form the record format of the database into dialling instructions, and transmitting the dialling instructions to a calling unit;
initiating a plurality of calls from a calling unit based on the received dialling instructions;
verifying that the connected call is answered by a person, and upon verification transferring the call to an interactive voice response unit;
determining the connected persons natural language using a natural speech recognition engine, said engine responsive to voice input from the person wherein the natural language engine automatically determines the language of the person;
verifying a subscriber using a voice print secure identification procedure;
presenting the selected campaign in the determined language and temporarily storing payment details in response to the presented campaign, and responding to said answers in the determined language;
transmitting said payment details to an on line payment authorisation portal, said portal then initiating a payment transaction based on the received payment details;
updating campaign information stored on the database based on the outcome of said payment transaction.

10. A method as claimed in claim 8 wherein the voice print secure identification procedure receives a sample of the subscriber's voice and stores that sample for later retrieval and use to verify the subscriber's voice by comparing the retrieved sample with the subscriber's live voice sample.

11. A method as claimed in claim 10 wherein the sample of the subscriber's voice is analysed and one or more characteristics of the analysed sample stored in a database and when it is desired to verify the identity of a subscriber, the subscriber's live voice is analysed to determine one or more characteristics of the live voice and the one or more characteristics of the live voice are compared with the one or more characteristics of the sample voice stored in the database.

12. A method as claimed in claim 10 wherein the voice print secure identification procedure creates a biometric template of the subscriber's unique voice print by asking the subscriber to state a phrase or unique identifier in the subscriber's natural language and extracting distinctive vocal characteristics and/or the measurable acoustic patterns of the speech, said distinctive vocal characteristics or measurable acoustic patterns being stored in a secure database for later retrieval from the database, the retrieved distinctive vocal characteristics or measurable acoustic patterns being used to verify the subscriber by conducting a comparison against the subscriber's live voice sample.

13. A method as claimed in claim 8 wherein the voice print secure identification procedure converts the subscriber's speech from analogue into digital format.

14. A method as claimed in claim 8 wherein, the distinctive vocal characteristics are selected form one or more of tone, pitch, or cadence.
